(19) United States
(12) Patent Application Publication
(10) Pub. No.: US 2016/0362522 A1
(43) Pub. Date: Dec. 15, 2016

(54) TRUE NANOSCALE ONE AND TWO-DIMENSIONAL ORGANOMETALS

(71) Applicant: The Pen, West Hollywood, CA (US)

(72) Inventor: The Pen, West Hollywood, CA (US)

(21) Appl. No.: 14/738,829

(22) Filed: Jun. 13, 2015

(51) Int. Cl. C08G 79/00; H01B 1/12; C08G 73/06; H01M 4/60

(52) U.S. Cl. CPC C08G 79/00; H01M 4/608; H01B 1/12; C08G 73/0672

(57) ABSTRACT

A number of new classes of polymers with the potential for electrical conduction are introduced sharing a common theme, having metal atoms in direct contact with each other, bound in one and two-dimensional structures guided by steric, dipole and coordinating ligand factors. These new classes include a new family of metallole polymers in a polycyclic arrangement, for use both standing alone, and with chains of metal atoms coordinated to their electronegative backbone atoms, new polymers of group 13 and 14 metals and metalloids, with substituents connected through an electronegative bonding atom, and a new class of close stacked porphyrin polymers, assembled with short molecular linkers perpendicular to the faces of the porphyrin units. These new materials empower new classes of capacitors, batteries and electrical conductors, even superconductors.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office Patent file or records, but otherwise reserves all copyrights whatsoever.

### BACKGROUND

The rapidly growing field of nanomaterials holds out the promise of taking advantage of quantum electronic effects at the nanoscale by the creation of nanowires and thin nanosheets. However, as currently produced, nanowires in particular are still not sized down to the single atom sub-nanometer scale where such effects would be most pronounced. Being upwards of 10 nanometers in size, they should more properly be called nanorods, and what are called nanorods today are even larger.

In the conventional practice of organometallic chemistry, the organometallic reagents are generally thought of as a means for functional group change and/or chain building acting on other reagents, not intended as the primary component of the end product. Even where experiments have been done toward making polymers which include metallic atoms, the emphasis is generally on the non-metallic part of the polymerization process, and where if there are metal to metal bonds at all they are tenuous, discontinuous, strained, or unstable. [Polymer Degradation and Stability, 2011, 96, 1841]

With respect to the simple conduction of electricity there is simply not enough copper on the planet to provide for copper wiring for everyone, and the production of aluminum requires vast amounts of electrical power just to produce the metal itself. Realizing the full theoretical potential of conducting polymers holds out the promise of electrical conductors with reduced or even no actual metal content required.

Accordingly, there is a need to develop a new class of nanoscale polymeric materials, which we will call organometals, as distinguished from the usual usage of the word “organometallic,” with the primary emphasis on metal to metal bonds, while at the same time achieving regular one-dimensional or two-dimensional structures, so that the products behave as metals, but with vastly increased edge boundaries and surface areas, to take full advantage of quantum effects supportive of applications like new super capacitors, battery materials, and very efficient conductors, even superconductors. At the same time, some of the supporting materials for these new applications possess their own independent utility, which will also be broadly developed at the outset of the description below. For categorization purposes, all the new materials described herein are polymers with electrical conducting potential, usually realized through doping.

### OBJECTIVES OF THIS INVENTION

This application teaches how to use steric, dipole and electronegativity effects to induce metal atoms to bond together in regular and stable, one and two-dimensional nanoscale structures. To achieve this as a practical matter, methods are taught whereby either one or two stable anti-metal substituents are coordinated, or covalently bonded, to metal or metalloid (hereinafter collectively “metallic”) atoms, by electrochemical means, chemical reduction of metal atoms, dehydrocoupling, dissolving metal reductions or chemical vapor deposition (“CVD”), and where the substituent functional group then guides the structure desired. In this context, “anti-metal substituent” means a functional group having a non-metallic atom other than carbon and hydrogen (the definition of an “anti-metal” atom) being the atom bonded to or coordinated with the metallic atoms. This definition of “anti-metal” as used below is distinguished from the term “heteroatom” as commonly used in organic chemistry, which would also exclude carbon and hydrogen, but would include metals and metalloids.

The choice of a coordinating or a covalently bonded substituent for these purposes is determined by the method of this invention by the particular metal involved and its idiosyncratic properties. For the metals in groups 2 through 12, coordination structures are diverse, and compounds are ionic rather than covalent, with the exceptions being the family containing nitrides, carbides, etc., and where organometallic bonds to carbon are highly polarized and reactive. By contrast, in group 13 trigonal covalent bonding is usually the order of the day, with carbon organometallic bonds again very reactive. And for the metals in group 14 tetrahedral covalent bonding is inherent.

For specific example, to create extended linear chains of metal bonded copper or silver atoms this application teaches how to construct in some embodiments new formulations of nitrogen atom rich coordinating polymeric backbones, which for all future purposes we will refer to as polycyclo-pyrrole (PCPy) and polycyclo-pyrazine (PCPz), designed so that the coordinating ligand nitrogen atoms are structurally spaced to correspond to the distance of metal-metal bonds, where metal atoms can then be deposited in those liganded positions, or for use standing alone for other electrical conduction and power storage purposes. In the case of nitrogen in a PCPy type structure, there is also a useful reduced oxidation state, and this method can be extended to other metalloles.

In another embodiment, methods are taught for achieving discreet layers of a two-dimensional stanene product, which can be visualized as having the tin atoms arranged in an extended hexagonal cell pattern, extensible to other Group 14 metallic atoms, and favored in this structure by opposing dipole interactions between adjacent metallic atoms created by attached anti-metal substituents.

In other embodiments, aluminum atoms, for example, are induced to bond in linear chains, strengthened by anti-metal substituents acting as electron donating groups, extensible to other Group 13 metallic atoms.

And in yet further embodiments copper or silver ions bound in a porphyrin derived structure are put into a close linear contact chain by linking the porphyrin units together edgewise perpendicular to their planes, with options for other metal atoms there as well.

As a broad overview, all the methods disclosed herein have a singular guiding theme, using anti-metal covalently bonded or guiding coordinate functional groups to encourage the metal atoms into the desired positions as they bond or connect together in the synthesis process.

### BRIEF DESCRIPTION OF THE DRAWINGS

FIG. 1 is a representation of the polymeric unit in polycyclo-pyrrole (PCPy).

FIG. 2 is a representation of the polymeric unit in a polycyclo-metallole reduced by two electrons in relation to polycyclo-pyrrole.

FIG. 3 is a representation of the polymeric unit in polycyclo-pyrazine (PCPz).

FIG. 4 is a representation of the polymeric unit in a generalized and fully oxidized polycyclo-metallole.

FIG. 5 is a representation of a porphyrin modified according to the method of this invention in one embodiment with amine linking points in the 5 and 15 porphyrin numbering positions.

FIG. 6 is a representation of metal complexed porphyrin subunits stacked togther with short edge linkers perpendicular to their faces.

### PRIOR ART

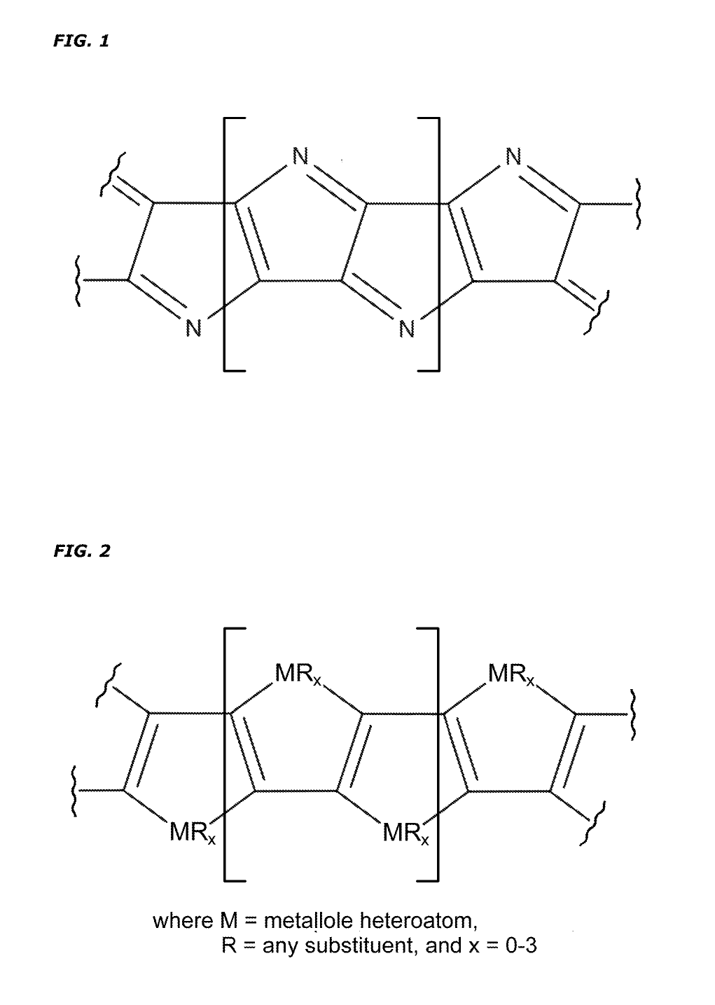

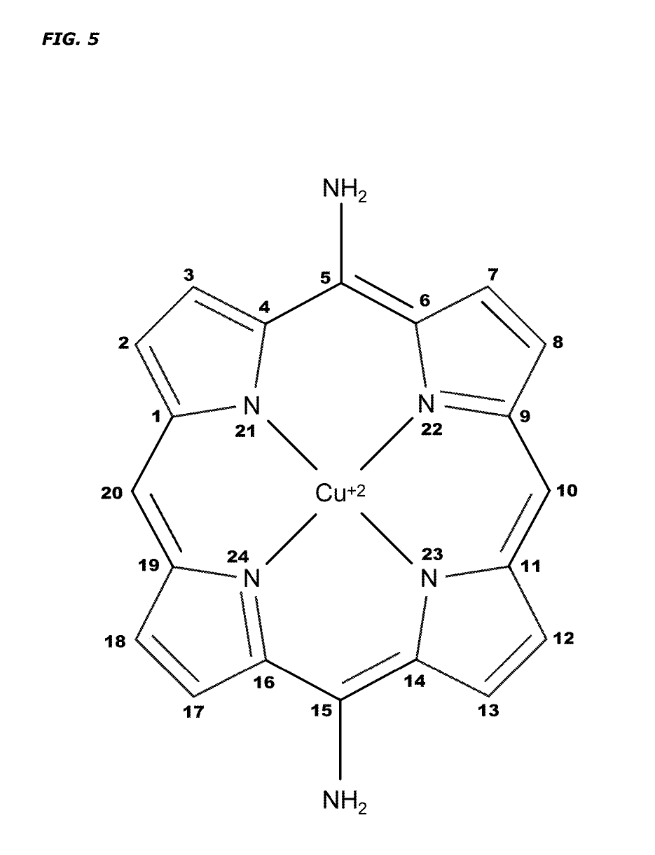

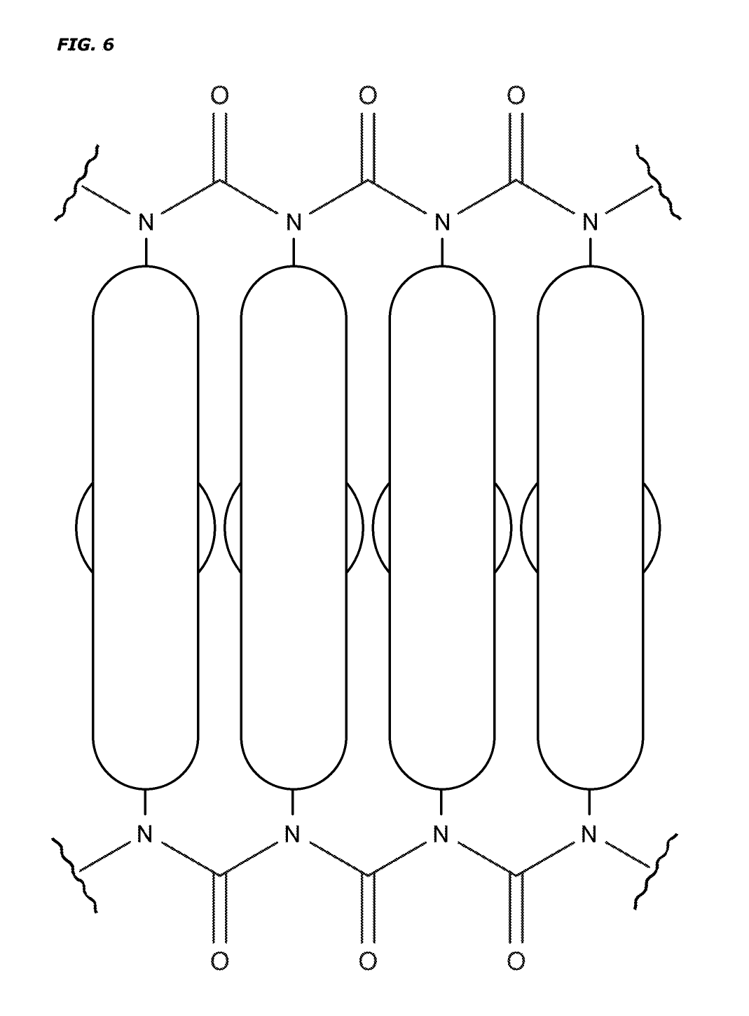

There are only sparse prior examples of direct metal to metal bonds in polymers with the exception of the Group 14 atoms, and there mostly attempts to synthesize linear polystannanes and polysilanes which we will address separately in a moment. Otherwise all one mostly finds are examples of isolated pairs of metal atoms bonded together and incorporated somewhere into a chain [Alaa S. Abd-El-Aziz, Ian Manners, Frontiers in Transition Metal-Containing Polymers, A John Wiley & Sons, Inc., 2007, p. 288, Equation 7.1], metal atoms alternating with other bonding atoms along a chain [J Organomet Chem, 2014, 751, 67], or larger clusters of metal atoms embedded in an overall polymerized material [Acc Chem Res, 2014, 47 (2), 579, FIG. 5; J Appl Phys, 2011, 109, 104301, FIG. 1; Macromolecular Research, 2012, 20 (10), 1096, Scheme 1; U.S. Pat. No. 7,988,887; U.S. Pat. No. 6,334,965; U.S. Pat. No. 5,919,402]. None of these just recited examples enable the kind of continuous metal atom to metal atom contact on a true nanoscale which is the objective sought by this invention.

With regards to published syntheses of the polystannanes already mentioned, these have been limited to examples of alkyl or aryl groups [Adv Mater, 2008, 20, 2225; Appl. Organomet Chem., 2011, 25, 769; J Organomet Chem, 2011, 696, 3041; Macromolecules, 2007, 40, 7878, Table 1], and on occasion hydrogen [Canadian Journal of Chemistry, 02/2011, 65(8), 1804, Equation 1], as additional substituents bonded to each tin atom, with such compounds proven to be sensitive to light decomposition and moisture.

U.S. Pat. No. 5,488,091 (“Tilley”) claimed polystannanes with substituents that might include alkoxy and other anti-metal substituents as defined here. However, there is no evidence that Tilley ever attempted to synthesize any such compound, in practical application focusing entirely on “dialkyl-, diaryl-, and mixed alkyl-, aryl-hydrostannanes.” Tilley, col. 3, lines 52-54. In particular, Tilley did not disclose the geometry of a two-dimensional product consisting of planar polycyclic hexagonal rings, what would theoretically be called a decorated (that is mono-substituted) stanene, specifying only that a mono-substituted hydrostannane starting material could result in “branched” products. Col. 3, lines 54-57. Moreover, Tilley's method, employing bulky transition metal complexes for his dehydrocoupling reactions, unlike the sterically compact dehydrocoupling catalysts taught herein in one embodiment, could not achieve a stanene structure if that was the objective, instead favoring linear chains in all cases. Col. 8, lines 38-42.

There was a purely theoretical study published in 2013 showing representations of decorated stanene with one non-tin substituent per tin atom, which might have included halogens or an alcohol [Phys Rev Lett, 2013, 111, 136804, FIG. 1]. The authors of the paper proposed no actual synthesis route except a generic reference to molecular beam epitaxy (and various exfoliation techniques presuming the pre-existence of the material in bulk), where any substituents would be provided from a separate component apparently participating in some kind of in situ chemical reaction during a polymerization process, which would not provide meaningful control over the exact number of substituents added per individual metallic atom. Another purely theoretical paper from 2015 depicted hydrogen decoration [Small, 2015, 11 (6) 640]. And just recently there has been a paper submitted claiming the achievement of a stanene containing tin alone, or oxidized after the fact by hydrogen peroxide, by a method of “ultra-fast light matter interaction in liquid ambience followed by hydrazine treatment,” with no other suggestion of any inherent and integral substituents. [http://arxiv.org/abs/505.05062, submitted for publication]. In short, if any method had been heretofore disclosed, by Tilley or anyone else, for achieving as a practical matter a decorated stanene, the most recent theoretical reviews surely would have taken note of it.

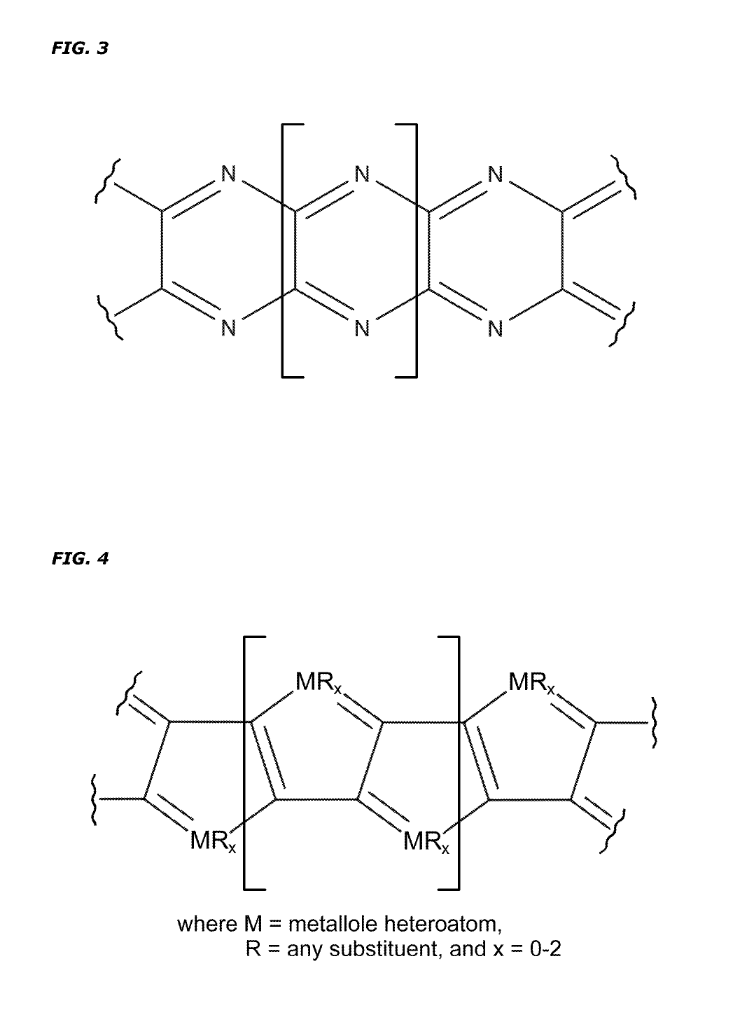

Linear polysilanes substituted with chlorine or hydrogen atoms have been obtained [Advances in Polymer Science, Silicon Polymers, Muzafarov, A. M (ed.), Vol. 235, 2011, “Modern Synthetic and Application Aspects of Polysilanes: An Underestimated Class of Materials?,” A. Feigl, A. Bockholt, J. Weis, and B. Rieger, p. 3, FIG. 3], and there are alkyl and aryl polysilanes [J Organomet Chem, 2000, 611, 26, Scheme 1; Advances In Organometallic Chemistry, 2004 Elsevier Inc., Joyce Y. Corey, “Dehydrocoupling of Hydrosilanes to Polysilanes and Silicon Oligomers: A 30 Year Overview,” Volume 51, p 1, Table II, p. 19] There is an instance of a claimed polygermyne with hydrogen substituents (sometimes referred to as germanane), in a stanene style configuration, obtained by decomposing a zintl compound. [Adv Mater, 2000, 12 (17), 1278; Acc Chem Res, 2015, 48, 144-151], and there have been various network polymers [Electrochemistry 2003, 71, 257; Macromolecules, 1993, 26, 869; Appl Phys Lett, 1994, 65, 1358]. But previous attempts were handicapped from their outset from achieving the kind of results demonstrated here because they did not apply the key electron donating, steric and dipole teachings of this application, which if respected enable this entire class.

And metal to metal polymerization of Group 13 metallics has never before been attempted where there are anti-metal atom bonds involved, though there is one isolated example of purported “polymers” [U.S. Pat. No. 3,508,886], with too many substituents to enable the full metal to metal atomic interactions taught herein.

Taken altogether there appear to be no meaningful examples in the literature of attempts to polymerize Group 14 metallic atoms, which would be exclusive of carbon, with a single anti-metal substituent bonded to each metallic atom by a non-metallic atom from Group 15, 16 or 17, and likewise for polymerization of Group 13 metallic atoms. This application seeks to fill in these inventive gaps with enabling teachings.

There have been examples of porphyrin structures necklaced together with intervening bonding ligands. [Journal de Physique Colloques, 1983, 44, C3-633] or edge linked in a plane [Chem. Commun., 2011, 47, 10034, Scheme 2; U.S. Pat. No. 8,865,025; U.S. Pat. No. 8,669,359]. It has been noted that porphyrins have an inherent tendency to stack [J Phys Chem, 1995, 99, 7632, FIG. 1], but no previous worker has attempted to join porphyrin structures incorporating complexed metal atoms face to face so that there is a continuous chain of close contacting metal atoms, achieved through the method of this invention by utilizing short molecular edge linkers perpendicular to the face of the porphyrins. Other workers have only contemplated longer, extended linkers. [New J Chem, 1999, 23, 885; Photochemistry and Photobiology, 1989, 49 (5), 531; Bull Chem Soc Jpn, 2001, 74, 907; Nature, 1994, 369, 727; J Biol Inorg Chem, 2007, 12, 1235] In this one embodiment only, the metal atom is technically in its full ionic state, though the net charge of the metal-porphyrin salt adduct is neutral.

Keeping this general overview in mind, additional specific prior art references are provided below to show how they are distinguished from the various novel embodiments herein. A substantial number of closely related patents have been granted for conductive polymers with some degree of conjugation and the participation of heteroatoms, especially recently, with increasingly byzantine formulations. It suffices for the purposes of the the IDS filed with this application to cite one representative example from each of the active researchers. A quick scan of the molecular structures depicted therein discloses no examples of extended polycyclic heteroatom rich polymers, not constantly interrupted by loose single bonds, as distinguished from the structures taught in this application in various embodiments, which is where we will now begin.

### DESCRIPTION

As a first order of business in creating some of the new polymeric structures described above we will need to create new linear ribbon chain backbone polymers rich in bonding ligands. So that these chains will maintain a relatively stiff straight line orientation, they will be polycyclic. There are some examples of structures of so-called ladder polymers of this sort, but more heteroatom poor than those disclosed here, which is critical for the purpose of embodiments which require a close spaced lineup of such atoms [G. Insulate, Conducting Polymers, Monographs in Electrochemistry, Springer-Verlag Berlin Heidelberg, 2012, p. 21, for example poly(2-Aminodiphenylamine); Protein Engineering, 1987, 1 (4), 295, FIG. 2]. Otherwise most previous conducting polymers are interspersed with various single bonds [Alan J. Heeger, MRS Bulletin, November 2001, 900, discussing his Nobel prize in the field]. It cannot be emphasized enough that any single bonds not conformationally constrained to be coplanar with the double bonds they are supposed to be conjugated with, appearing in what is intended as a conductive structure, is fatal to the theoretical potential of that conductivity.

One example is conventional polypyrrole, with pyrrole molecules linked from their 2 to their 2′ (or 5′, the same where the pyrrole is its own mirror image) positions. Leaving aside the influence of metal atoms for just a moment, if one would hope to create a conducting solely organic polymer, single atom bonds which can twist make the pi-transfer of electrons through a presumptively conjugated chain of alternating single and double bonds imperfect. The theoretical point of various ladder-like polymers is to lock the polymer chain in a ribbon-like plane for full conjugation. Additionally, anywhere in such a structure that an embedded benzene moiety can be looked at in isolation this becomes an electronic sticking point that is happy being its own island of resonance. And by incorporating more nitrogen atoms in particular into new ladder polymer structures, by the method of this invention we can achieve more facile pi-electron conjugation.

As demonstrated by the following:

Starting with pyrrole,3,4-diamine, a structure can be synthesized as in FIG. 1, which we shall call polycyclo-pyrrole (PCPy). One facile route to this objective is to reduce commercially available 1-(1-methylethoxy)-1H-pyrrole-3,4-diamine (CAS No. 927415-80-3) with LiAlH₄ to the desired starting material, a quantitative reaction. Then under acidic conditions this can be electrochemically oxidized [as for standard polypyrrole, Synthetic Metals, 2014, 191, 104] and/or chemically oxidized by FeCl₃ [Chem Commun, 2012, 48, 8246; J Phys Chem B, 2005, 109, 17474; U.S. Pat. No. 5,855,819], or ammonium persulfate [Journal of Physics: Conference Series, 2009, 187, 012050], etc., to polymerize to the desired end product.

In the synthesis of conventional polypyrrole the carbon atoms at the 2 and 5 positions are counted on to preferentially stabilize the presumed radical intermediates, due to their proximity to the electron donating nitrogen atom in the ring, through there are still side products. One would think that amines in the 3 and 4 positions of pyrrole would disturb this regioselectivity. But if we perform the reactions under acidic conditions, in the range of about 2 to 5 pH, both the primary amino groups are protenated as salts (with the amines themselves acting as buffers), and become electron withdrawing groups instead, with the deactivating reverse effect at positions 3 and 4. The nitrogen in the 1 ring position of pyrrole does not protenate under these conditions, as the existing bound hydrogen of simple pyrrole is relatively acidic to begin with, as reflected by its pKa of 16.5, due to the influence of two vinyllic connections, whereas the peripheral amines in this material have only one each, and less acidic for that reason, and not being part of the ring as well.

Given that the protonated 3,4-aminopyrrole is a polarized molecule, its orientation can be constrained in a strong magnetic, electric or electromagnetic field, or any combination of them, where each is oriented on a different axis [see for example http://arxiv.org/abs/1501.03702, physics.chem-ph, submitted for publication]. Accordingly, in other embodiments the polymerization reaction can be conducted in such fields, which act to orient the resulting polymer also directionally. And it is expressly anticipated that this method can be extended to any polymerization reaction where the polarity of the reactants can in this manner assist in such specific orientation.

To further control the regiospecificity of the PCPy synthesis, another preferred route is to start with commercially available 4-amino-3-pyrrolidinol (CAS No. 77898-64-7). Here the alcohol can easily be oxided to the ketone, whereupon exhaustive alpha and gamma iodination and elimination yields 2,5-diiodo-4-amino-azol-3-one. This can be converted to the mono-boronic ester by single equivalent Miyaura borylation. Whichever iodine goes in this process, the intermediate products can be isolated and separated respectively, and Suzuki coupled to themselves with perfect polymer regiospecificity, whereupon conjugated imine formation by the addition of acid completes the polycyclization, and where the iodo-Suzuki coupling proceeds in quantitative yields.

Having demonstrated that the PCPy polymer can be synthesized, we will now proceed to incorporate chains of metal atoms, encouraged to assemble coordinated with such a structure by the close spaced ligands in the PCPy backbones. An elegant way of doing this is to use as an oxidizing agent an ionic metal salt of the very metal we want to incorporate. It is already known that Ag+1 ions will oxidize and polymerize pyrrole. [Synthetic Metals, 2013, 166, 57] We can use silver in this way, or alternatively Cu+2 which is close to the silver ion in reduction potential, or even Cu+1, or Ag+2 from silver (II) oxide, which is thought to consist of one silver atom in the +1 oxidation state and one in the +3, and a strong oxidizer for this reason. In this manner, as each reduction takes place in the polymerization of 3,4-aminopyrrole, by the method of this invention, as each metal ion falls out of solution in its zero oxidation state there are nitrogen ligands right there to shepherd it into position. In this case electrochemical assistance is a concurrent option. As further options we can buffer the reaction solvent with additional tertiary amines, or add non-oxidizable chelating agents, such as those known by those skilled in the art to smooth standard plating reactions. Alternatively, silver can be deposited into fully preformed PCPy electrochemically.

The spacing of the nitrogen atoms on each side of the backbone of this new polycyclo-pyrrole material is about 360 pm, which is close to the van der Walls diameter of silver (345 pm) in its zero oxidation state. In the case of using silver or copper ions in their +1 oxidation state for the reaction, two atoms of metal are being deposited for each new nitrogen that extends the double chain on one side or another, with the possibility of another backbone chain liganding on the other side. With the +2 reagent ions it is only one atom of metal per nitrogen. Similar procedures can be carried out with other metal ions with sufficient redox potential, in particular gold and platinum, but silver and copper are the best natural conductors, with copper of course the most inexpensive and available. Less preferable, but still options, are other metal atoms in Group 2-12 that at least can be plated out of solution even if they are not themselves oxidizing polymerization agents.

These examples should be taken as the most simple implementation of close spaced nitrogen ligand backbones for this purpose, with two such backbone chains running tandem on each side of the molecular polymer ribbon. To achieve maximum resonance in this first case there are no points available for additional molecular connections on the liganded edge of the molecular ribbon facing out on either side. But one skilled in the art might assemble a single one of these ligand backbone edge atom chains, connected on the other side in any other arbitrary way, for connections for anchoring or other purposes, as long as the close spaced structure of the backbone itself is preserved as demonstrated.

Lest it pass unnoticed, we have further achieved by the method of this invention in this last embodiment dual modes of conductivity, by resonance through the main polymer backbone, together with conductivity through the tandem metal chains, using relatively small amounts of actual metal on a total mass ratio basis.

Also of interest are related structures in the form represented by FIG. 2, which though reduced by one 2-electron stage per repeat in relation to FIG. 1 remain fully conjugated and potentially conducting structures, an interesting and important point to observe. With nitrogen as the heteroatom, using our original starting material, this represents the variation of the PCPy already introduced with one additional substituent per nitrogen unit, in an intermediate oxidation state, were we to stop the reactions above at this point. One way to force this is to attach an additional alkyl, oxygen attached, carbonyl, or other group to each nitrogen atom in the starting pyrrole. Whatever the heteroatom in FIG. 2, the R groups could be any substituent that will bond to the heteroatom in any of its possible oxidation states. In this construction the structure can be seen as having embedded in it a structurally locked analog of cis-polyacetylene, with idealized potential conductivity for that reason. Furthermore, in this case the additional groups attached to nitrogen atoms can be used as linkers to other structures, with total control of what linkers are on the respective tandem sides, including for the purpose of enhanced solubility, which has always been an issue with polyacetylene itself.

It is otherwise another objective of this invention to enable unprecedented electrical power storage capabilities, in one embodiment by the transition from the form in FIG. 2 (still highly conductive) to the form in FIG. 1, and back. Consider an electrochemical cell with an acidic electrolyte and an insulating porous separator where both electrodes in the fully discharged state consist at least in part of polycyclo-pyrrole, one of which electrodes we will arbitrarily choose to be the anode and the other the cathode. Applying a charging current to this cell converts the anodic material to the form of FIG. 2, with hydrogen as the R group (in this half cell consuming acidic hydrogen), whereas the cathodic material is also converted to a material in the form of FIG. 2, but with either hydroxy (with consumption of water), alkoxy (with alcohol) or the counter-anion of the acid in the electrolyte (depending on the choice of acid) as the R group (all freeing acidic hydrogen).

This is a battery with no memory effect (in its fully discharged state not even as to which terminal is supposed to be which), with potentially unlimited charging cycles, and with the electrodes formed as highly porous materials with large surface areas having immense power density. For electrode fabrication purposes, using the electrochemical synthesis method above PCPy can be deposited as a film directly onto conducting porous material of any kind, including graphite and carbon nanotube aerogels, first allowing for the starting material to fully diffuse throughout. And to eliminate the possibility of polymer decondensation at the cathode the electrolyte can be anhydrous or incorporate alcohols instead of water, or additional ammonia can be dissolved in the electrolyte. It is interesting to note that if an isopropoxide of nitrogen was to form it would be the same bond chemistry as in the original molecular source material for our PCPy synthesis above, 1-(1-methylethoxy)-1H-pyrrole-3,4-diamine, where we began by removing the alkoxide, meaning that battery electrodes can also be produced in their charged formulations.

Likewise parallel FIG. 2 structures can be created with group 16 atoms like sulfur and oxygen, in other embodiments using alternate synthesis methods because conversion of those atoms to electron withdrawing groups is less facile than with nitrogen substituents in the 3 and 4 positions. In the case of sulfur there are examples in the scientific literature of short oligomers limited to as many as eight sulfur atoms so arranged, but no attempts at full polymerization. [Chem Asian J, 2009, 4, 1386, 1395, FIG. 6]. Such short constructions will not conduct very far, a critical difference if conductivity is the objective, such that for this purpose what are properly called polymers have a fundamentally different character from what are called oligomers. To achieve a proper and full polymer, by the method of this invention, 3,4-thiophenedithiol (CAS No. 87207-45-2) can be selectively brominated in the 2 and 5 positions, in one preferred embodiment the loose thiols can be protected as a thio-acetal, and then Rieke zinc at −78° C., and subsequent treatment with the nickel catalyst Ni(dppe)Cl₂, will effectuate the 2-2′ polymerization [J Am Chem Soc, 1995, 117 (1), 233]. Deprotection of the thiols under acidic conditions then completes the double cyclization into polycyclo-thiophene, PCTh, with condensation on conjugated thione intermediates.

Alternatively, one of the thiols could be replaced with hydroxy, and following the Miyaura-Suzuki scheme described above for PCPy we can achieve a parallel result. Higher oxidation states of polycyclo-thiophene, with oxygen atoms on sulfur also support battery applications, for example, in the charged state with the PCTh just described as the anodic material, and with the sulfur atoms oxidized to their +6 state, bonded also to two oxygens, as the cathodic material. In one embodiment the form in FIG. 2 can be used alone. A PCPy based battery in another embodiment can be constructed in a similar manner, with higher oxidation states of nitrogen akin to this last sulfur example.

By like means a polycyclo-furan product, PCFu, incorporating oxygen atoms is also available through Suzuki or other couplings, using furans in the form of enol ethers in the 3 and 4 positions, and employing dehydrating conditions for the final condensations. Such enol ethers are also a path to PCPy, in other embodiments by condensing them with ammonium acetate after deprotection, with a sulfur source for PCTh, etc. And corresponding structures with other Group 15 and 16 atoms can also be contemplated by these means, including mixing heteroatoms in the same polymer, though the full functional beauty of these new structures as conductive polymers is found in the perfection of their symmetry.

It is even possible to incorporate metalloids in these structures, for example with silicon as the heteroatom with two methyl groups each. 1,1-dimethylsilole is a known compound, and stable at −78° C., slowly forming Diels-Alder dimers at room temperature [J Organomet Chem, 1981, 209, C25]. Additional substitutents on the ring carbons provide additional stability. Accordingly, starting with commercially available 1,1-dimethyl-2,5-dihydro-1H-silole (CAS No. 16054-12-9), treatment with one equivalent of BuLi creates an anion in the 3 position where despite the beta silicon effect the hydrogens on the alkene are still more acidic than the secondary alkyl hydrogens in the 2 and 5 positions. This can be silated with dimethyl-trifluoromethyl-chlorosilane (or alternatively dimethylmethoxychlorosilane), with inverse addition of the anion to preferentially expel the chorine. Exhaustive iodination (or bromination) and elimination with non-nucleophilic base adds iodines (or bromines) in the 2 and 5 positions and completes the oxidation to the full silole, with now 2 double bonds, which opens the door to conversion first to the mono-boronic ester by Miyaura borylation. Whichever iodine goes in this process, the intermediate products can be isolated and separated respectively and Suzuki coupled to themselves with perfect polymer regiospecificity, whereupon treatment with strong non-nucleophilic base abstracts the sole remaining vinyllic hydrogen (pKa 43) of each silole unit in the 4 position slowly, with then fast nucleophilic attack on the adjacent 3′-silyl group, ejecting a trifluoromethyl anion (conjugate acid pKa 25-28) to complete the polycyclization to polycyclo-silole, PCSi. Alternatively, the silyl linkage polymerization can be performed first to avoid the possibility of cross-linked products, in one embodiment with the addition of halides in the 2 and 5 positions subsequently. Solubility of the polymer product in all embodiments above, where there is room for substituents on the hetero ring atom, can be enhanced by attaching longer substituents than methyl to it, including alkyl chain and ether linkages, sulfate termination, etc.

Another route to PCSi is from 1,1-dimethyl-2,5-iodo-3,4-dimethylmethoxysilyl-silole, obtained in a parallel manner as just above, which can then be polymerized with acetylene under Sonogashira conditions, preferably by reacting with a large excess of the acetylene first to isolate the 2,5-ethynyl derivative, and then repeating the Sonogashira reaction with an equal equivalent of the previous di-iodo material. This polymer will then undergo dual silyl internal ring formation on each of the acetylenic units by treatment with lithium naphalenide, followed by iodine quenching [J Am Chem Soc, 2003, 125 (45), 13663, Scheme 2]. Here again trifluoromethyl anion can be the leaving group from each new silyl linker, an innovation by this applicant to boost yields, as it will mostly likely only be disturbed by a strong carbanion in close quarters.

Moreover, it is expressly anticipated that these same principles could be extended to any other polycyclo-metallole. The expression metallole is commonly understood to include a variety of unsaturated 5 membered ring heterocycles, whether the heteroatom incorporated is technically a “metal” or not, including all the Group 13, 14, 15 and 16 heteroatoms, plus titanium and zirconium. Those in the form of FIG. 2 where the heteroatom can sustain three covalent bonds or more, if hydrogen or other labile substituents are employed, can be further oxidized to the generalized form of FIG. 4, replacing what was the nitrogen of PCPy in FIG. 1. These can even be interconverted amongst themselves, for example by reaction with phenylboron dichloride to produce phenyl substituted polycyclo-borole, PCBo. Polycyclo-phosphole, PCPh, is another material with battery potential given the facile multiple oxidation states of phosphorus, along the same lines as the PCTh battery chemistry example above. There were some proposals by one of the original inventors of polyacetylene, and others, to store charge by p- and n-type doping of that material [U.S. Pat No. 4,442,187], and another scheme using polyaniline [U.S. 4,820,595]. The materials taught herein are superior for battery applications because they not only participate in full-fledged redox reactions in both directions (rather than just charge doping,) but also retain their full conjugated conductivity in all forms.

It is further the insight of this applicant that all the chain creation reactions described herein are perhaps less than optimally performed in conjunction with stirring, which tends to tangle the growing chains, whereas what we want in various embodiments are highly ordered structures, in principle the more crystalline the better. For this reason a two-compartment reaction device may be used to minimize turbulence, separated by a membrane or other porous separator permeable to some reactants but not other larger ones. So for a typical example in the case just above, a key small molecule component of the metal coupling reaction, in one embodiment an activating base for a platinum or palladium chloride derivative, can be added to one compartment and allowed to diffuse slowly into the other where the reaction takes place.

Likewise, parallel procedures to those employed for our PCPy can be applied to the production of the novel polycyclo-pyrazine (PCPz), FIG. 3. In one embodiment the penultimate material is 2,3,4,5-tetraamino-2,3-dihydropyrazine, a previously unreported compound. But starting with commercially available 2,2-diaminoacetic acid (CAS. No. 103711-21-3), this is first double BOC protected, and then converted directly into the amide using B(OCH₂CF₃)₃ and an excess of ammonia [J Org Chem, 2013, 78 (9), 4512], which after deprotection can then be self cyclized using Et₃OBF₄ [by analogy to J Org Chem, 1968, 33 (4), 1679]. This tetraamino-dihydropyrazine will undergo a trans-amidine condensation under the same acidic conditions as for polycyclo-pyrrole above, and then can be electrochemically oxidized to polycyclo-pyrazine standing alone, or by using oxidizing metal atoms, again as above, including for the parallel purpose of laying down coordinated linear chains of metal atoms. Another synthesis option is to replace the aminos at positions 5 and 6 of a dihydropyrazine with ketones, in one embodiment with the polycyclization aided by again Et₃OBF₄.

Moving to the stanene objective, or what in the first instance is described as a decorated stanene (with one anti-metal substituent per tin atom), it is already known that polymerizing tin with various di-alkyl or aryl substituents does not lead to stable products, being both light and moisture sensitive. So before even attempting our own tin atom polymerizations of any kind, we can promote the stability of our end products by using more electron donating functional groups, preferably alkoxy, though secondary amine, amide, ester, sulfide, or other any other such electron donating group can be used, the purpose being to stabilize by induction the tin to tin bonds, where the bond between the metallic atom and the anti-metal substituent is through an anti-metal atom in Groups 15 and 16. And we will not perforce exclude the halides in Groups17, because they exert a dipole effect, as do all these other functional groups just mentioned.

The dipole effect we speak of is related to the anomeric effect in sugars. According to theory, there are two competing considerations there. First, in cyclo molecules with more bulky substituents, steric effects will favor having them in the equatorial positions, precisely what we don't want for the formation of two-dimensional sheet structures. Second, where the substituent is electronegative, a dipole is created which will favor opposing axial orientation between adjacent ring atoms, so that the dipoles do not repel, which also favors formation of 6 membered rings as opposed to 5 membered rings. This latter effect is more pronounced in non-polar solvents. We eliminate the first concern in two ways by the method of this invention, by keeping the substituents sterically small, and by taking advantage of the longer bonds between metallic atoms in the rings, longer than the carbon-carbon bonds in sugars. Second, because the electronegativity difference between metals and our anti-metal substituent connecting atoms is greater, all other things being equal, than their electronegativity difference from carbon, the dipole effect is stronger than in the sugar model. Both these considerations now favor axial positioning, and have been theoretically ignored by previous attempts to use large alkyl and aryl substituents with minimal electronegativity differences in the connecting bond atoms. In addition, certain substitutents like amides offer inter-substituent hydrogen bonding possibilities which work further in our favor.

So starting for example with trichloromethoxystannane, available from reacting tin tetrachloride with ¼ equivalent of methanol, this can polymerized electrochemically, or by means of a dissolving metal reduction, to yield the methoxy decorated stanene. Sonification helps to drive these reactions to completion. Alternatively, this same starting material can be reduced to methoxystannane (the trihydride) with LiAlH₄, and then deposited by small complex dehydrocoupling catalysts, or CVD. There is one example in the scientific literature of the accidental incorporation of a very minor fractional portion of some methoxy in what was intended as a purely mono-alkyl polystannane, because unreacted chlorines were quenched with methanol [Polymer, 2000, 41, 441, FIG. 2c].

It is worth noting again that the few previous attempts that might have resulted in mono-substituted polystannanes by dehydrocoupling have yielded linear polymers with one hydrogen remaining on board each tin atom, because the catalyst was too bulky to proceed further [J Organomet Chem, 1985, 279, C11], or else have resulted in network polymers. [Macromolecules, 1990, 23, 3423; Electrochimica Acta, 1999, 45, 1007] For this reason, the smallest possible dehydrocoupling catalysts are recommended according to the method of this embodiment, to minimize steric hindrance, for example platinum or palladium halides, which can be hydride or base activated in situ. All these transition metal catalysts are most efficient when coordinated at least in part to electron donating ligands, including various amines, imines and nitriles, which can be multi-dentate. This was what is referred to by a “small complex dehydrocoupling catalyst,” specific preferred examples of which would include coordinating the metal with two acetonitrile ligands, diammine, (1E,2E)—N,N′-dimethyl-1,2-ethanediimine, TMEDA (tetramethylethylenediamine), and similar small footprint molecules.

The stability problem with previous linear polystannanes once synthesized is that they decompose into cyclic structures. But in this embodiment it is our aim to create extended cyclic structures as the most stable form. Given that ultimately the most stable thermodynamic form is in fact the stanene structure, the polymer structure can be perfected after synthesis by combinations of heat, pressure, and electromagnetic energy exposure (UV, microwave, etc.), remembering that the tin to tin bonds are still weaker than the tin-alkoxy bonds and will redistribute, presuming we do not apply so much kinetic energy that the result is solid solution precipitation of trialkoxy tin. Other polymerization conditions are known to those skilled in the art, presuming the selection of starting materials taught by this application is followed.

To obtain mono-halogenated products, in one embodiment fluorotrichlorostannne is the starting material, made by reacting tin tetrachloride with a ¼ equivalent of a fluoride salt in a nucleophilic reaction. Because the redox potential of fluorine is greater (and its bond to tin stronger) than that of chlorine, it is then possible to remove the chlorines selectively by control of the driving voltage across the electrochemical cell. This enables a path to a structure which was heretofore purely theoretical. And from fluorostannane, dehydrocoupling and CVD are also options.

However arrived at, as a decorated structure with mono substituents in alternating anti positions, these form a buffer layer on the surface of the two-dimensional structure, which tends to passivate it, and the two-dimensional layers can then assemble into a bulk three-dimensional material, as does graphene in graphite. While stanene itself has properties of a topological insulator, conductivity is available at its boundary interfaces, which is the point of nanostructuring, or via doping.

In another exemplary embodiment we can arrive at fully oxidized stanene, with alternating aromatic type double bonds, by then doing elimination of these decorations. So for example, halogen decoration can be removed with hydrides or in a dissolving metal reaction, and then the whole structure can be oxidized using catalysis by base, transition metal dehydrogenators, etc.

As an alternative, a bromine decorated stanene can be subjected to ½ equivalent of LiAlH₄ to remove ½ the bromines, and in the presence of a tertiary amine or other non-nucleophilic base the other half of the bromines can be eliminated with extended resonance mechanisms. One starting material for this purpose, bromostannane, can be obtained by dropwise inverse addition of three equivalents of sodium bis(2-methoxyethoxy)aluminumhydride (Red-Al) in toluene to tetrabromostannane in the same solvent under inert atmosphere, with the reaction being driven also by the precipitation of NaBr. The addition is slowed near the end of the addition to minimize full reduction to the pyrophoric stannane gas, whereupon the bromostannane (highly flammable if not pyrophoric itself) boils off at a low temperature as it forms, and can be condensed at 0° C. directly into a second connected flask containing the dehydrocoupling metal complex catalyst right there.

And these same principles can be extended to any of the other Group 14 metals and metalloids which will form tetrahedral covalent bonds to obtain stanene style structures. For example, methoxysilane (CAS No. 2171-96-2) is commercially available, and can be used as it comes for dehydrocoupling or CVD as already taught herein. Similarly, one skilled in the art could substitute in the coupling reactions any other functional groups besides hydrogen or halides that can be reduced off with the generation of metal to metal bonds.

We now endeavor to synthesize stable linear polymetal chains. In contrast to the known (and known unstable) di-alkyl and di-aryl polystannanes, parallel attempts to incorporate the other substituents taught above (other than chlorine in the case of silicon) are conspicuously absent from the actual research literature. Here the electron donating properties of most of the anti-metal substituents already mentioned tend to strengthen the metal-metal bonds, making these compounds more stable. In the case of the Group 14 metals and metalloids, we can simply use the above procedures on the di-substituted metal compounds, dimethoxydichlororstannane, dimethoxystannane, etc. In addition, with the latter, dehydrocoupling, in this case using a sterically hindering catalyst like Wilkinson's catalyst (the optimum large complex dehydrocoupling catalyst) to discourage cyclization, is a favored embodiment for removing hydrogens. The evolving hydrogen produced can be allowed to simply boil off, or be captured with a sacrificial alkene like cyclohexene.

As other means of encouraging linear chains, liganding and sterically guiding helper molecules can be used also in alkali metal reductions, for example crown ethers in liquid ammonia, and these same principles apply to electrochemical working solutions as well, again using smoothing chelating agents. Both these are examples of using molecular structures to semi-protect the metal atoms until they form metal to metal bonds. Furthermore, it is also possible to pre-synthesize seed chains of more than six metal atoms in length, separate out any cyclized product, and then extend those seed chains by dropwise addition of more starting material, where extension of the seed chains is then favored over cyclization reactions.

In other embodiments, the new one and two-dimensional structures taught herein can be co-deposited and intercalated with electrically insulating molecules, to enhance the isolation of the conducting metal channels. For example silicon dioxide can be dissolved in superheated water at 340° C., and then cooled to drop out of solution interspersed around the linear chains, or between the two-dimensional stanene layers already realized.

Extending these principals to the Group 13 metals, here tetrahedral boding is not an option, so we will first consider mono-substituted metals for chain formation. In the case of aluminum, the choice of alkoxy substituents is again considered to be the most stable at normal temperatures, both as an end product, and manageable under the various reaction conditions above. Highly electronegative substituents like fluorine must be handled with care at least until the metal atoms are consolidated into a bulk solid material, as when mono or di-substituted they are more reactive than pure aluminum, which itself is flammable as a finely divided powder. But the formulation will work for any of the substituents considered above for poly-Group 14 applications. And discouraging ring cyclization by any of the means just above again favors linear chains.

In a typical procedure, aluminum tribromide is reacted with one equivalent of methanol in otherwise dry organic solvent added dropwise to produce methoxydibromoalane. This can then be coupled electrochemically or by dissolving metal reduction. Or the remaining bromines on the methoxyalane can be reduced off by NaH, and subjected to either large complex dehydrocoupling catalysts or CVD, again as above. Alternatively, as an intermediary product a mixed halo alkoxy alane can be reduced with a pure aluminum hydride like NaAlH₄, which after giving up a hydride equivalent becomes incorporated as part of the product, and then redistributed in the reaction itself. In this latter case, for example, if the objective was the equivalent of one alkoxy substitutent per aluminum atom, equal portions of Al(OMe)₂Br and NaAlH₄ would be combined to achieve that net end proportion. Whether by redistribution or not, the polymer starting material can be isolated and purified, demonstrating the advantage of these methods for exact control over the number of substituents per metallic atom. One skilled in the art will now appreciate that by the method of this invention any intermediary proportion of anti-metal substitutents can be achieved down to what would be considered mere doping level.

These are the first polyaluminum organometals, and clearly distinguished from Flagg, et al.[U.S. Pat. No. 3,508,886, already cited], both in method and end result. Flagg claimed a “polymer” produced by reacting various aluminum hydrides with HF gas. All that could ever hope to accomplish would be the replacement of hydride substituents with fluorine substituents on the aluminum atoms, and regardless of any other substitutents would in no case reduce them to create actual metal to metal bonds, but instead an ionic coordination network. And when Flagg attempted his method with pure aluminum trihydride [his Example 2] the reaction went further awry by reacting with and incorporating the THF solvent used as a third substituent (in addition to two fluorines on each aluminum atom), with apparently no room provided for metal-metal bonds.

One skilled in the art will now recognize that the linear chains of polyaluminum taught herein, once created, will associate with other chains, each conducting electron exchange as in a true metal. In this manner these one-dimensional structures assemble themselves into three-dimensional bulk materials. This is not only true of the mono-substituted product, as bonding either one or two substituents only to an aluminum atom will tend to predispose it to coordination type bonding to other aluminum atoms, more like the transition metals. Any metal atom that will tri-bond can be used by the method of this invention in a similar way. Moreover, with regards to all the one and two-dimensional polymetallic structures described above, alloys mixing combinations of different metallic atoms are also anticipated embodiments.

Lastly, another application of ligand coordinated structuring of metal to metal atom contact will now be demonstrated in the form of close perpendicular edge linking of metal ion porphyrin complexes. In biological systems, a metal ion in such an environment, already coordinated to four nitrogen atoms, will readily accept electrons from additional electron donating ligands, like molecular oxygen or carbon monoxide. In a similar manner, when such metal ions are held in direct proximity, they can transfer elections from one to another, conducting electricity.

To create these structures we will require functional group substituents on the periphery of the porphyrin complexes for linking purposes. In one preferred embodiment, a Grignard reagent is made from 2-bromopyrrole (CAS. No. 38480-28-3). This can then be reacted with pyrrole-2-carbonyl chloride (CAS No. 5427-82-7) to give the ketone, which when reacted with ammonia to give the primary ketimine can then be reduced to the amine by sodium cyanoborohydride, or alternatively formic acid. With that in hand, reaction with any simple aldehyde will complete the four sub-unit cyclization to a porphyrin type structure. If desired the peripheral amine function can be protected during the subunit ring formation, or the ketones first formed can be protected as ketals and reduced to amines at the end.

This product can then be complexed with Cu+2 ion to give copper porphyrin with amino groups ending up in the 5 and 15 positions according to porphyrin structure numbering, FIG. 5. Perpendicular linking and stacking of the porphyrin units, FIG. 6, can then be achieved by dropwise addition to them of two equivalents of a phosgene equivalent, and where any discontinuities (two adjacent aminos each with a loose acyl choride already attached) are healed by the liberated chloride ions regenerating phosgene with the ejection of trisubstituted nitrogen as a leaving group, after one of the acyl chlorides forms a bridge with it. This can be further facilitated by the addition of an iodide salt, like KI.

We note that the distance across the linked nitrogens is 180 pm in this case, very close to the size of the Cu+2 ion, so the stacking distance is optimum. Moreover, if any elemental copper was to be formed, the size of copper in reducing to its zero oxidation state increases to 280 pm, no longer a good fit for the liganded porphyrin central cavity, and will be displaced by another copper atom still in the ionic state, or will be reoxidized in that highly conducive environment.

With this close perpendicular linking teaching in mind, one skilled in the art might adopt any manner of other linking strategies suitable for single chain polymers, using other linking functional groups or other positions on the periphery of the porphyrin complexes, for example radical initiated vinyl chloride in place of the amine linking points, or including additional linking points at the 10 and 20 positions for tetra-linking. In the case of polymerized vinyl chloride linkers, elimination of the chlorines is a known route to the conducting polymer polyacetylene, and the same path can be followed with polyvinyl bromide.

In other variations the porphyrin derivatives can be extended with additional peripheral structures as long as the core four ligand arrangement remains intact, and other double bonds could be moved around or hydrogenated in any arbitrary manner that does not disturb the bonding state of the core nitrogens themselves, though a carbaporphyrin is allowed by less preferred. Parts of the porphyrin structure could even be cut away and replaced with other linkages, or other anti-metal atoms substituted, as long as the result is a flat stable structure.

Furthermore, beyond copper the principle of this structure can be extended to any other metal ion that will similarly complex with a porphyrin, including silver, which in the porphyrin cavity environment is oxidized to the +2 state, magnesium, iron, etc. In another embodiment, the attachment of electron withdrawing or electronegative groups, for example fluorine or trifluoromethyl, to the periphery of the porphyrin, including positions 2, 3, 7, 8, 12, 13, 17, and 18, will tend by induction to reduce the bonding distance of the ligand nitrogens, so as to better accommodate slightly larger ions.

Simply stated, what is claimed in this last embodiment category are essentially four atom ligand coordination units (porphyrin equivalents) containing a complexed metal ion, linked directly together with polymer chains perpendicular to the plane of the complexed units so that the successive metal ions are in electronic contact distance with each other. This stack represents the first true nanowire with a core of exact one single chain of metal atoms.

Taken together, all of the embodiments above teach related methods of using coordinating ligands, dipole effects, and/or sterically controlling functional groups to structure metal atoms joined in direct contact in one and two-dimensional, even and regular structures, stabilized by appropriate electron donating effects, to maximize their conductivity potential on a quantum level. The nitrogen ligand backbone structuring polymers required for guiding some of these structures have their own conducting and metallic character, and can be used separately for that purpose, as can related structures with other heteroatoms. And we should reiterate before concluding that any of these structures can have their conductivity greatly enhanced by doping, as is already known for different but chemically comparable compositions by those skilled in the art.

Those skilled in the art will appreciate that the present invention may be susceptible to variations and modifications other than those specifically described. It will be understood that the present invention encompasses all such variations and modifications that fall within its spirit and scope.

I respectfully claim:

1. A polycylic heteroatom rich polymer with a repeating unit as depicted in either FIG. 1, FIG. 2, FIG. 3, or FIG. 4.

2. The polymer of claim 1, where metal atoms in the zero oxidation state are co-deposited with and coordinated to the heteroatoms in the polymer.

3. The polymer of claim 2, where the metal atoms are either silver or copper, and the heteroatoms are nitrogen.

4. The polymer of claim 1 used to store or provide electrical power.

5. The polymer of claim 4, where the polymer participates in a redox reaction as a component in the anode or the cathode of a battery.

6. The polymer of claim 1 where the polymer is produced under the influence of magnetic, electric and/or electromagnetic fields to orient the polymer molecules.

7. A two-dimensional organometal polymer comprising,
a) Group 14 metallic atoms, with each such metallic atom with metallic bonds to three other such metallic atoms, arranged in planar polycyclic hexagonal rings,
b) where each such metallic atom also has a fourth bond to an anti-metal substituent, where the fourth bond is to an anti-metal atom from Group 15, 16 or 17, in the anti-metal substituent,
c) synthesized under minimally sterically hindering conditions.

8. The polymer of claim 7, where the minimally sterically hindering conditions are selected from the group of small complex dehydrocoupling catalysts, electrochemical polymerization, dissolving metal reduction, and CVD.

9. The polymer of claim 7 incorporating a dopant other than an anti-metal substituent.

10. The polymer of claim 7 intercalated with electrically insulating molecules.

11. The polymer of claim 7 where the structure is perfected by means selected from the group of heat, pressure and electromagnetic energy exposure, in any combination.

12. A one-dimensional organometal polymer comprising,
a) Group 13 metallic atoms, with each such metallic atom with metallic bonds to two other such metallic atoms,
b) where each such metallic atom also has a third bond to an anti-metal substituent, where the third bond is to an anti-metal atom from Group 15, 16 or 17, in the anti-metal substituent.

13. The polymer of claim 12, synthesized under conditions selected from the group of
(a) large complex dehydrogenation catalysts,
(b) electrochemical polymerization or dissolving metal reduction in the presence of coordinating chelating agents, and
(c) CVD.

14. The polymer of claim 12 incorporating a dopant other than an anti-metal substituent.

15. The polymer of claim 12 intercalated with electrically insulating molecules.

16. A metalloporphyrin polymer comprising
a) porphyrin equivalent units, each coordinated in its central cavity to an oxidized metal ion,
b) where porphyrin equivalent units are stacked together, joined at their edges by molecular linkers perpendicular to the faces of the porphyrin units,
c) closely spaced so as to put the metal ions in direct linear contact with each other.

17. The polymer of claim 16, where the linkers are attached to positions 5 and 15 of the porphyrin units, and optionally also to positions 10 and 20.

18. The polymer of claim 16, where the metal ion is selected from the group of copper, silver, magnesium and iron.

19. The polymer of claim 16, where the linkers act as conducting polymers.

20. The polymer of claim 16 where electron withdrawing or electronegative groups are substituted at any of positions 2, 3, 7, 8, 12, 13, 17, and 18, of the porphyrin units.
